(19) United States
(12) Patent Application Publication
(10) Pub. No.: US 2011/0232423 A1
(43) Pub. Date: Sep. 29, 2011

(54) Combination Beverage Can Opener and Cover

(76) Inventor: Keith Raymond, Minneapolis, MN (US)

(21) Appl. No.: 13/036,312

(22) Filed: Feb. 28, 2011

Related U.S. Application Data
(60) Provisional application No. 61/316,479, filed on Mar. 23, 2010.

(51) Int. Cl. B67B 7/44; B67B 7/40

(52) U.S. Cl. 81/3.09; 81/3.55

(57) ABSTRACT

A combination beverage can opener and cover comprises a semi-circular sheet of plastic having a top surface and a bottom surface and a straight diametric edge having an arcuate notch located proximate the center of the edge. A tab is connected by a living hinge to a circumferential edge of the device midway along its circular perimeter. When used as an opener for a beverage can having a stay-on tab, the device is first slipped under the can's pull ring and used to lift the pull ring so as to rupture the prescored tab and bend it down into the can. To affect closure, the device is rotated about the can's rivet attachment until the semicircular sheet of plastic overlays the opening through which the contents are dispensed.

### CROSS REFERENCE TO RELATED APPLICATIONS

The applicant claims the benefit of pending provisional application Ser. No. 61/316,479, filed Mar. 23, 2010, and entitled “Combination Beverage Can Opener and Cover”, the contents of which are hereby incorporated by reference.

### BACKGROUND OF THE INVENTION

1. Field of the Invention

This invention relates generally to the field of pop top beverage container openers and more particularly to a combination opener and cover for inhibiting spillage and loss of carbonation following the opening thereof.

2. Discussion of the Prior Art

Early metal beverage cans had to opened by a can-piercing tool commonly referred to as a “churchkey”. A beverage can was opened by punching two triangular holes in the lid—a large one for drinking, and a second (smaller) one to admit air. In 1962 Ermal Cleon Fraze of Dayton, Ohio, invented an integral rivet and pull-tab arrangement referred to as “ring pull”, which had a ring attached at the rivet for pulling, and would come off completely to be discarded. Mr. Fraze was awarded U.S. Pat. No. 3,349,949 for his pull-top can design. While that invention provided improved convenience, the pull-tabs were an environmental problem. People opened cans, ripped off the pull-tabs and threw them to the side because there was nothing else to do with these removable metal pieces. Pets and wildlife died from ingesting them, as did a few people who dropped them into a can and accidentally choked on them. These pull-tabs wound up everywhere—from beaches and parks, to playgrounds and garbage disposals.

A stay-on tab beverage can typically comprises a scored closure formed directly atop the lid of an aluminum can and an opening ring riveted to the top and having a portion overlaying the scored closure and a longer portion extending away from the scored closure such that the pull ring forms a lever of the first class whose fulcrum is the rivet. By lifting the pull ring, sufficient force is applied to the scored closure to force it downward into the container, thereby creating an opening in the lid. In this arrangement, the scored closure and pull ring remain attached to the can and are disposed of together after the contents of the can have been consumed.

Prior to opening, the pull ring lays flat against the can lid, typically below the can's rim. To open the can, a user typically will use fingernails to raise the pull ring a sufficient distance to allow the pull ring to be grasped between a thumb and forefinger. When so grasped, the pull ring is pivoted upwardly about the rivet fulcrum to bend the scored closure down into the can.

The above-described beverage can with self-contained opener is rather universally utilized. However, it has certain drawbacks. The act of initially lifting the pull ring sufficiently far to allow it to be grasped, often results in broken fingernails especially with women who tend to have longer manicured nails. Moreover, bartenders and the like must perform the opening maneuver frequently during the course of a workday and this can lead to significant discomfort.

A variety of tools are disclosed in the prior art for facilitating the opening of pop top cans. However, these tools tend to be devices separate from the can itself and are not always handy to a user. For example, the Farelli U.S. Pat. No. 6,070,497 and the Phillips U.S. Pat. No. 4,967,622 describe such tools.

Another drawback to pop top beverage containers is that once they are opened, they are difficult to reseal to prevent accidental spillage and to maintain the contents fresh. What is needed is a combination tab lever lifting device and cover. The Takayama U.S. Pat. No. 6,015,059 describes a cover arrangement for a beverage can in which a semicircular film layer having an adhesive band around its perimeter is designed to fit under the pull ring of a beverage can and it adhesively attach to the can lid in covering relation to the opening in the lid. It cannot be used to open a pop top beverage can. The Sarnoff et al. U.S. Patent Des. 358,311 illustrates a snap-on cover that engages the can rim and which includes an integrally formed radial extension having a slot in which a beverage can pull ring will fit and by lifting the device, the scored closure will be punctured and following that maneuver, the cover can be removed from the pull ring and then snapped over the can's lid. While this device of the Sarnoff et al. '311 patent performs the desired function, it is overly costly to produce and thus cannot reasonably be incorporated as a feature of the can itself and thus must be considered a reusable rather than a disposable combination opener/cover for a pop top beverage can.

Thus, there is a need for a very low cost accessory that can be incorporated as a feature of the beverage can and first used to facilitate the opening of the scored closure and then selectively moved into a sealingly relationship with the now-opened can in a simple maneuver. The present invention provides just such a device. It cannot be used to open a pop top beverage can.

### SUMMARY OF THE INVENTION

In its simplest form, the present invention preferably comprises a molded plastic, somewhat flat sheet, that is in the form of a semicircle where the diameter of the semicircle has an arcuate notch at its center and is adapted to partially surround the rivet used on practically all pop-top can lids to hold the pull ring to the beverage can lid. The diameter of the semicircle is dimensioned so that the device will fit within the upstanding rim of the beverage can with a relatively close tolerance. The undersurface of the semicircular piece is slightly concave over a majority of its surface to conform to the slightly domed contour of most beverage can lids. Located approximately midway along circumference of the semicircle is a rounded tab that is slit or scored to form a “living hinge” allowing it to be bent upward when a user is ready to open the can. In its initial position, the device of the present invention underlays the pull ring and when the tab on the device is grasped between a thumb and forefinger and lifted, it will act as a lever to raise the pull ring causing the rings' front portion to bear down on the can's scored closure causing it to rupture and expose the beverage can's opening. At this point, a user may pour the contents of the can into a glass or drink directly from the open spout.

When it is desired to reclose a beverage can with the contents partially consumed, the user merely grasps the now-bent rounded tab and rotates the semicircular closure member about the rivet until the device is in covering relation with respect to the can's opening.

### DESCRIPTION OF THE DRAWINGS

The foregoing features, objects and advantages of the invention will become apparent to those skilled in the art from the following detailed description of a preferred embodiment, especially when considered in conjunction with the accompanying drawings in which:

FIG. 1 is a perspective view of the combination beverage can opening device and closure;

FIG. 2 is a top view of the device of FIG. 1;

FIG. 3 is a bottom perspective view of the device of FIG. 1;

FIG. 4 is a cross-sectional view taken along the line 4-4 in FIG. 3;

FIG. 5 shows the position of the device on the lid of a beverage can prior to its use as an opener for lifting the can's pull tab; and

FIG. 6 shows the device when rotated to a closing position relative to the beverage can's opening in the lid.

### DESCRIPTION OF THE PREFERRED EMBODIMENT

This description of the preferred embodiments is intended to be read in connection with the accompanying drawings, which are to be considered part of the entire written description of this invention. In the description, relative terms such as “lower”, “upper”, “horizontal”, “vertical”, “above”, “below”, “up”, “down”, “top” and “bottom” as well as derivatives thereof (e.g., “horizontally”, “downwardly”, “upwardly”, etc.) should be construed to refer to the orientation as then described or as shown in the drawings under discussion. These relative terms are for convenience of description and do not require that the apparatus be constructed or operated in a particular orientation. Terms such as “connected”, “connecting”, “attached”, “attaching”, “join” and “joining” are used interchangeably and refer to one structure or surface being secured to another structure or surface or integrally fabricated in one piece, unless expressively described otherwise.

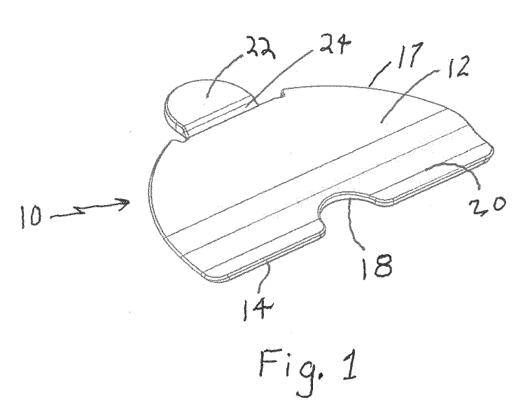

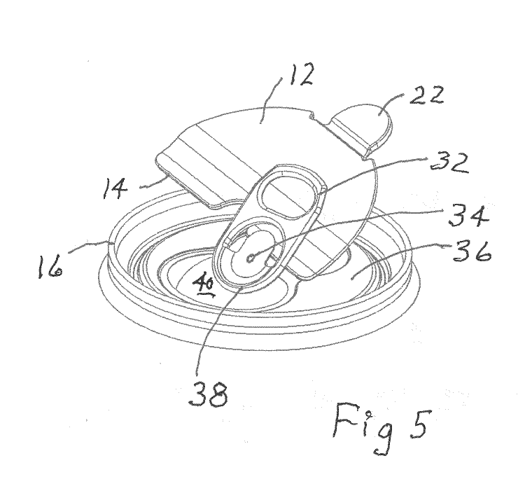

Referring first to FIG. 1, there is indicated generally by numeral 10 a preferred, exemplary embodiment of the present invention. It is seen to comprise a molded plastic sheet 12 that is generally semicircular having an edge diameter 14 whose length is dimensioned so that it generally corresponds to the inside diameter of a standard beverage can's upwardly extending rim which is identified in FIG. 5 by reference numeral 16. In the U.S. and Canada, this dimension is typically a litter over 65 mm. In European countries, it is about 52 mm. Without limitation, the sheet 12 may have a thickness of about 0.40 mil at its circumferential edge 17.

Formed midway along the diameter 14 is an arcuate notch 18 which is adapted to fit about the rivet commonly used to secure the pull ring of a pop top beverage can to the lid itself.

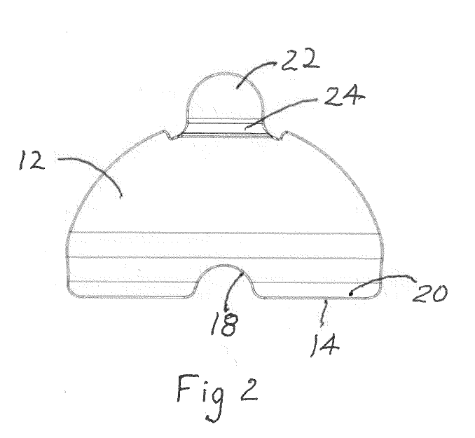

With continued reference to FIG. 1, the sheet 12 has a downwardly sloping tapered area 20 leading to the edge diameter 14 that is specifically shaped to facilitate placement under the pull-tab of a beverage can. The series of parallel line in FIGS. 1, 2, 5 and 6 indicate the area over which the taper extends.

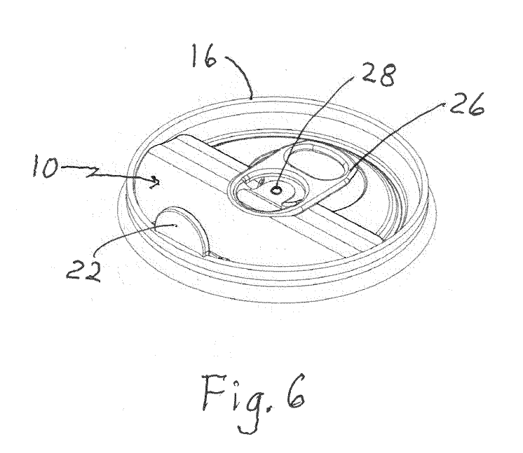

Centered midway along the circumferential boundary of the sheet 12 is a rounded tab 22. The tab 22 is slit or relieved as at 24 to form a living hinge that facilitates its ability to be bent upwards so as to extend generally perpendicular to the plane of the sheet 12 as is seen in FIG. 6.

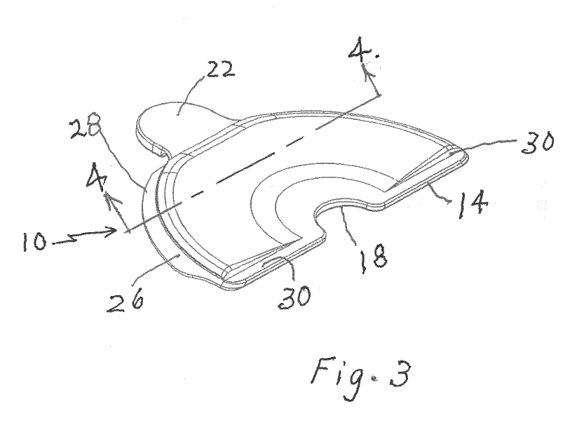

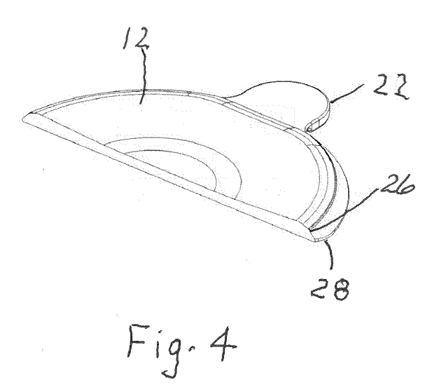

FIG. 3 is a view of the underside or a bottom surface of the combination beverage can opener and cover as can be seen in that view and perhaps even more so in the cross-sectional view of FIG. 4 that is taken along the line 4-4 in FIG. 3, the arcuate peripheral edge of the device is tapered, as at 26, to intersect with the top surface at a thin or sharp edge 28. In addition, the bottom surface is slightly concave as represented by the concentric semicircular construction lines in FIGS. 3 and 4. Thus, the bottom surface conforms to the convex dome surface of a standard beverage can having a stay-top opener. A portion of the device proximate the straight diametric edge is also relieved, as at 30, to a lesser thickness to form somewhat of a wedge that facilitates insertion of the device between the pop top opening lever and the domed lid of the beverage can as seen in FIG. 5. The opener and cover shown in FIG. 3 differs slightly from the embodiment disclosed in the afore referenced provisional application Ser. No. 61/316,479 in that instead of having a protrusion on the bottom surface conforming to the shape of the can opening, in the embodiment disclosed herein the bottom surface is slightly concave.

Without limitation, the sheet 12 may be formed from a suitable plastic that is approved for use with consumable products and with polypropylene being preferred.

FIG. 5 shows the combination stay-top beverage can opener and cover device of the present invention being initially installed beneath the pull ring 32 on a stay-top beverage can lid. It is seen to fit under the pull ring 32 and when fully installed will have the arcuate notch 18 in surrounding relation to the rivet 34 used to hold the pull ring 32 to the can's lid 36. At this point, the tab 22 will remain coplanar with the sheet 12 and will extend over the rim 16 of the can where it can readily be grasped by the user's thumb and forefinger. By pulling upward on the tab, it will now raise the pull ring 32 causing its distal end 38 to press downward on the scored closure 40 rupturing the closure and forcing the closure 40 downward into the interior of the can. At this point, the tab 22 will fold along the slit or relieved area 24. When it is desired to reclose the can, the device 10 can be rotated from its disposition beneath the pull ring 32 to the position illustrated in FIG. 6 of the drawing with the arcuate notch 18 partially surrounding the rivet 34. Reopening, of course, merely involves again slightly lifting and rotating the member 10 about the rivet 34 so as to again reside under the pull ring 26 where the can opening is no longer covered. Because of the mating relationship between the concave undersurface of the device 10 and the raised arcuate dome of the can lid, there is practically no leakage of non-carbonated beverage even if the beverage can is inverted.

In that the device of the present invention can be readily fabricated in an injection molding operation using a suitable die, it can be produced in mass at a small fraction of a cent and treated as a disposable with the can itself.

This invention is clearly new and useful. Moreover, it was not obvious to those of ordinary skill in this art at the time it was made, in view of the prior art.

It will thus be seen that the objects set forth above, and those made apparent from the foregoing description, are efficiently attained and since certain changes may be made in the above construction without departing from the scope of the invention, it is intended that all matters contained in the foregoing construction or shown in the accompanying drawings shall be interpreted as illustrative and not in a limiting sense.

1. A combination beverage can opener and cover comprising a semicircular sheet of plastic having a top surface and a bottom surface and a straight diametric edge interrupted by an arcuate notch at a center point thereof and with a tab connected by a living hinge to a circumferential edge midway along its circular perimeter.

2. The combination beverage can opener and cover of claim 1 wherein said bottom surface has a concave contour.

3. The combination beverage can opener and cover of claim 1 wherein said top surface is tapered in to a lesser thickness at said diametric edge.

4. The combination beverage can opener and cover of claim 1 wherein said bottom surface has a tapered peripheral edge.

5. The combination beverage can opener and cover of claim 1 wherein the plastic is polyurethane or a polyurethane blend.

6. The combination beverage can opener and cover of claim 1 wherein the diametric edge is of a length about equal to a diametric distance measured within an upstanding rim of a beverage can.

7. The combination beverage can opener and cover of claim 1 wherein a maximum thickness of the sheet permits placement thereof between a beverage can lid and the beverage can's pull tab prior to lifting of the pull tab to pen the can's op-top seal.

8. The combination beverage can opener and cover of claim 6 wherein the sheet of plastic is rotatable within the rim of a beverage can with the arcuate notch enclosing a rivet fastener securing a beverage can's pull tab to the beverage can's lid.

9. A combination beverage can opener and cover comprising:
a semicircular sheet of plastic having a top surface, a concave bottom surface and a straight diametric edge interrupted by a generally semicircular notch at a center point thereof with the top surface tapering from a first elevation to a lesser elevation at said diametric edge, and an arcuate tab connected by a living hinge to a circumferential edge midway along its circular perimeter.

10. The combination beverage can opener and cover of claim 9 wherein the bottom surface of the sheet is tapered to a lesser thickness proximate said circumferential edge.

11. The combination beverage can opener and cover of claim 9 wherein the diametric edge is about 65 mm long.

12. The combination beverage can opener and cover of claim 9 wherein the diametric edge is about 52 mm long.
